(19) United States
(12) Patent Application Publication
(10) Pub. No.: US 2010/0142116 A1
(43) Pub. Date: Jun. 10, 2010

(54) CAPACITOR

(75) Inventors: Woon-Chun KIM, Suwon-si (KR); Sung Yi, Suwon-si (KR); Soon-Gyu Yim, Seongnam-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/482,104

(22) Filed: Jun. 10, 2009

(30) Foreign Application Priority Data
Dec. 4, 2008 (KR) 10-2008-0122545

(51) Int. Cl. H01G 4/255; H01G 4/06

(52) U.S. Cl. 361/272; 361/313

(57) ABSTRACT

A capacitor is disclosed. The capacitor in accordance with an embodiment of the present invention includes a first electrode, a dielectric substance, which is formed on the first electrode, a second electrode, which is formed on the dielectric substance, and a magnetic layer, which is interposed between the dielectric substance and at least one of the first electrode and the second electrode. In accordance with the present embodiment, dielectric loss can be reduced while minimizing the reduction of capacitance of the capacitor.

### CROSS-REFERENCE TO RELATED APPLICATIONS

This application claims the benefit of Korean Patent Application No. 10-2008-0122545, filed with the Korean Intellectual Property Office on Dec. 4, 2008, the disclosure of which is incorporated herein by reference in its entirety.

### BACKGROUND

1. Technical Field

The present invention relates to a capacitor.

2. Description of the Related Art

A capacitor is an electronic component consisting of a pair of electrodes separated by a dielectric substance, and stores electrical energy between the pair of electrodes. The capacitance of the capacitor, which is inversely proportional to the distance between the electrodes and proportional to the area of the electrodes, can be expressed by the following equation.

$$C = ε \frac{A}{d}$$

whereas, C is capacitance, ε is a dielectric constant, A is the area of the electrode, and d is the distance between the electrodes.

To increase the capacitance, capacitors often use a dielectric substance with a high dielectric constant. However, dielectric substances with a higher dielectric constant usually have greater dielectric loss, restricting the increase of capacitance.

To reduce such dielectric loss, a stacking structure, in which a dielectric substance with a higher dielectric constant and an insulator with a relatively lower dielectric constant are stacked, has been introduced, but the overall capacitance of the capacitor is significantly reduced due to the lower dielectric constant of the insulator.

### SUMMARY

The present invention provides a capacitor that can lower dielectric loss.

An aspect of the present invention provides a capacitor. The capacitor in accordance with an embodiment of the present invention includes a first electrode, a dielectric substance, which is formed on the first electrode, a second electrode, which is formed on the dielectric substance, and a magnetic layer, which is interposed between the dielectric substance and at least one of the first electrode and the second electrode.

The magnetic layer can made of a material comprising at least one selected from a group consisting of cobalt (Co), iron (Fe) and nickel (Ni).

The magnetic layer can be interposed both between the first electrode and the dielectric substance and between the second electrode and the dielectric substance.

The dielectric substance can include a first dielectric layer, and a second dielectric layer, which is formed on the first dielectric layer and has less dielectric loss than the first dielectric layer.

A dielectric constant of the second dielectric layer can be greater than 4 and smaller than a dielectric constant of the first dielectric layer.

The second dielectric layer can be made of a material comprising metal oxide.

In this case, the metal oxide can be an amorphous substance.

The metal oxide can made of a material comprising at least one selected from a group consisting of BiZnNb oxides, BiTi oxides, BiNb oxides, BiCuNb oxides and BiMgNb oxides.

The first dielectric layer can be made of a material comprising polymer resin and a conductive substance.

The conductive substance can be made of a material comprising at least one selected from a group consisting of carbon black, carbon nanotube, carbon nanowire, carbon fiber, metal, metal oxide and graphite.

The second dielectric layer can be formed on one surface and the other surface of the first dielectric layer.

The second dielectric layer can be formed to surround the first dielectric layer.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view illustrating a capacitor in accordance with an embodiment of the present invention.

FIGS. 2 to 4 are cross-sectional views illustrating a deformed capacitor in accordance with an embodiment of the present invention.

FIGS. 5 to 10 are cross-sectional views illustrating each process of manufacturing a capacitor in accordance with an embodiment of the present invention.

### DETAILED DESCRIPTION

A capacitor according to a certain embodiment of the present invention will be described below in more detail with reference to the accompanying drawings. Those components that are the same or are in correspondence are rendered the same reference numeral regardless of the figure number, and redundant descriptions are omitted.

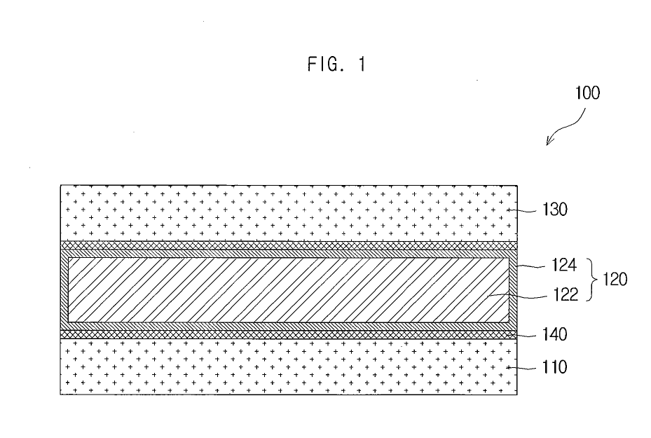

FIG. 1 is a cross-sectional view illustrating a capacitor 100 in accordance with an embodiment of the present invention.

As illustrated in FIG. 1, the present embodiment presents a capacitor that includes a first electrode 110, a dielectric substance 120, which is formed on the first electrode 110, a second electrode 130, which is formed on the dielectric substance 120, and a magnetic layer 140, which is interposed between the dielectric substance 120 and at least one of the first electrode 110 and the second electrode 130.

In accordance with the present embodiment, dielectric loss can be reduced while minimizing the reduction of capacitance of the capacitor 100.

Below, each of the components will be described in more detail with reference to FIG. 1.

According to the capacitor 100 based on the present embodiment, the first electrode 110 and the second electrode 130 are formed on either surface of the dielectric substance 120. Here, the magnetic layer 140 is interposed between the first electrode 110 and the dielectric substance 120 and between the dielectric substance 120 and the second electrode 130.

As such, by interposing the magnetic layer 140 in between the dielectric substance 120 and the first electrode 110 and the second electrode 130, the dielectric loss of the dielectric substance 120 can be significantly reduced while not affecting the capacitance of the capacitor 100. Here, dielectric loss means energy loss that is caused when the dielectric substance 120 absorbs energy from an electric field and converts it to heat, and shall have several meanings including the dissipation factor and leakage current.

In other words, a magnetic field is formed between the first electrode 110 and the second electrode 130 by the magnetic layer 140, and thus, when a leakage current flows in this magnetic field, the magnetic field can exert a magnetic force on electrons, which constitute the leakage current. Since resistance is applied to the electrons of the leakage current by the magnetic field of the magnetic layer 140, the flow of the leakage current is interrupted, thereby significantly lowering the dielectric loss such as the leakage current of the dielectric substance.

Here, the magnetic layer 140 can be made of a material including cobalt (Co), iron (Fe) or nickel (Ni), or a material including at least two selected from them, for example, an alloy thereof. Since cobalt (Co), iron (Fe) and nickel (Ni) described above are ferromagnetic substances, the magnetic layer 140 can be formed after depositing these substances by way of sputtering and supplying a magnetic field.

Furthermore, as illustrated in FIG. 1, the magnetic layer 140 is interposed both between the first electrode 110 and the dielectric substance 120 and between the second electrode 130 and the dielectric substance 120. Since the magnetic layer 140 is interposed both between the first electrode 110 and the dielectric substance 120 and between the second electrode 130 and the dielectric substance 120, the magnitude of the magnetic field, which exerts a magnetic force on the dielectric substance 120, can be increased, and thus the dielectric loss of the dielectric substance 120 can be reduced, as described above.

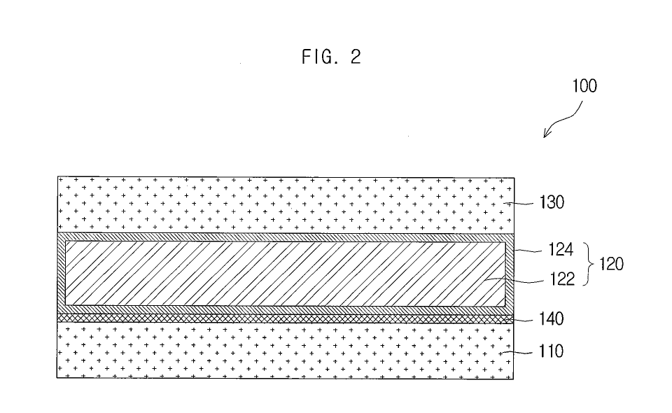

In this case, as illustrated in FIG. 2, the magnetic layer 140 can be interposed between the first electrode 110 and the dielectric substance 120. Here, FIG. 2 is a cross-sectional view illustrating a deformed capacitor 100 in accordance with an embodiment of the present invention.

Although FIG. 2 only illustrates the magnetic layer 140 interposed between the first electrode 110 and the dielectric substance 120, the magnetic layer 140 can be also interposed between the second electrode 130 and the dielectric substance 120, and it shall be evident that this method is also included in the scope of the claims of the present invention.

As described above, while interposing the magnetic layer 140 between the first electrode 110 and the dielectric substance 120, and between the second electrode 130 and the dielectric substance 120, as illustrated in FIG. 1, the dielectric substance 120 can be constituted by a first dielectric layer 122 and a second dielectric layer 124, which has less dielectric loss than the first dielectric layer 122, thus more significantly lowering the overall dielectric loss. Hereinafter, the dielectric substance 120 formed in this structure and its effects based on the structure will be described in more detail.

The dielectric substance 120 is constituted by the first dielectric layer 122 and the second dielectric layer 124, which is formed on the first dielectric layer 122. Here, the second dielectric layer 124 has less dielectric loss than the first dielectric layer 122.

As such, by forming the dielectric substance 120 in a multi-layered structure with the first dielectric layer 122 and the second dielectric layer 124 having less dielectric loss than the first dielectric layer 122, the overall dielectric loss of the dielectric substance 120 can be lowered, and at the same time the overall reduction of capacitance of the capacitor 100 can be also minimized. The overall capacitance of the capacitor 100 having the multi-layered dielectric substance 120 can be calculated by the following equation.

$$\frac{1}{Ctotal} = \frac{1}{C 1} + \frac{1}{C 2}$$

whereas, Ctotal is the overall capacitance of the capacitor 100, C1 is capacitance by the first dielectric layer 122, and C2 is capacitance by the second dielectric layer 124.

If an insulator having very low dielectric loss is formed on the first dielectric layer 122 to reduce the dielectric loss of the first dielectric layer 122, the dielectric loss of the entire dielectric substance 120 can be reduced. However, the dielectric constant tends to become smaller while the dielectric loss is reduced. Therefore, the overall capacitance of the capacitor 100 is significantly decreased by the above equation due to the decreased capacitance of the insulator.

On the other hand, if the dielectric substance 120 is formed in a multi-layered structure with the first dielectric layer 122 and the second dielectric layer 124 having less dielectric loss than the first dielectric layer 122, like the present embodiment, the second dielectric layer 124 can have a dielectric constant that is smaller than the first dielectric layer 122 but greater than the insulator. As a result, the dielectric loss of the entire dielectric substance 120 can be reduced, and at the same time the overall capacitance reduction of the capacitor 100 can be minimized.

Here, the second dielectric layer 124 can be made of a material having a dielectric constant of greater than 4 and less than the dielectric constant of the first dielectric layer 122. That is, the second dielectric layer 124 has a dielectric constant of greater than 4, which is the dielectric constant of silicon oxide (SiO₂), and less than the dielectric constant of the first dielectric layer 122.

In other words, as described above, a material having less dielectric loss and a smaller dielectric constant than the first dielectric layer 122 is used as the second dielectric layer 124 in order to reduce the overall dielectric loss of the capacitor 100. However, the second dielectric layer 124 having a dielectric constant of greater than 4 is used to minimize the overall capacitance reduction of the capacitor 100.

Meanwhile, the first dielectric layer 122 can be made of polymer resin and a conductive substance. That is, the first dielectric layer 122 can be a composite of polymer resin and a conductive substance. Here, the conductive substance can be made of carbon black, carbon nanotube, carbon nanowire, carbon fiber, metal, metal oxide or graphite, or a combination of at least two of them.

Furthermore, the second dielectric layer 124 is made of a material including metal oxide, more specifically, an amorphous substance. That is, the second dielectric layer 124 can be made of BiZnNb oxides, BiTi oxides, BiNb oxides, BiCuNb oxides or BiMgNb oxides, or a combination of at least two of them.

Here, Bi5Zn1Nb3/2O7(BZN) can be used for BiZnNb oxides, Bi2Ti2O7(BTO) for BiTi oxides, and Bi3NbO7(BNO) for BiNb oxides. Moreover, Bi2Cu2/3Nb4/3O7(BCN) can be used for BiCuNb oxides and Bi2Mg2/3Nb4/3O7(BMN) for BiMgNb oxides.

As illustrated in FIG. 1, the second dielectric layer 124 is formed such that the second dielectric layer 124 surrounds the first dielectric layer 122. That is, the second dielectric layer 124 can be formed such that the second dielectric layer 124 surrounds an outer circumference of the first dielectric layer 122.

As the second dielectric layer 124 is formed in such a way that the second dielectric layer 124 surrounds the first dielectric layer 122, the second dielectric layer 124 can be also formed on a side surface of the first dielectric layer 122, thus reducing the overall dielectric loss more effectively.

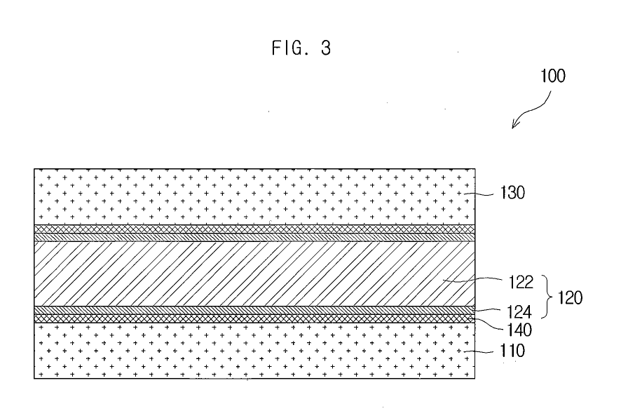

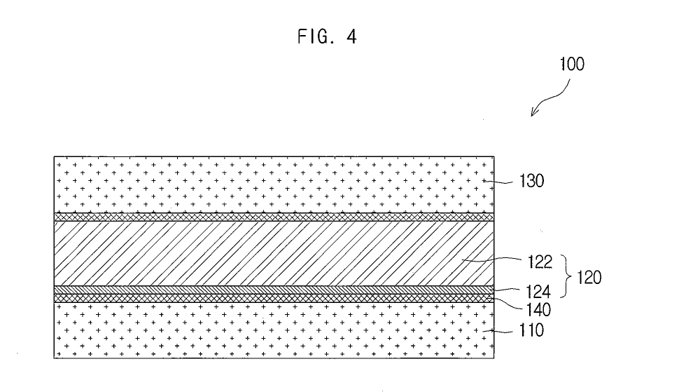

FIGS. 3 and 4 are cross-sectional views illustrating the deformed capacitor 100 in accordance with an embodiment of the present invention.

As illustrated in FIG. 3, the second dielectric layer 124 can be formed on one surface and the other surface of the first dielectric layer 122. Since the second dielectric layer 124 is formed both between the first electrode 110 and the first dielectric layer 122 and between the second electrode 130 and the first dielectric layer 122, the dielectric loss can be prevented effectively.

Furthermore, as illustrated in FIG. 4, the second dielectric layer 124 is formed on one surface of the first dielectric layer 122, so that it can be interposed between the first electrode 110 and the first dielectric layer 122.

Although FIG. 4 only illustrates the second dielectric layer 124 interposed between the first electrode 110 and the first dielectric layer 122, the second dielectric layer 124 can be also formed on the other surface of the first dielectric layer 122 such that the second dielectric layer 124 can be interposed between the second electrode 130 and the first dielectric layer 122, and it shall be evident that this method is also included in the scope of the claims of the present invention.

Hereinafter, referring to FIG. 1, a case where the dielectric substance 120 is made of the first dielectric layer 122 and the second dielectric layer 124, like the present embodiment, and a case where an insulator is formed on the dielectric substance, like the conventional technology, will be compared and described.

Table 1 compares a case where the second dielectric layer 124 made of BiZnNb oxides is formed on the first dielectric layer 122 made of polymer resin and a conductive substance (hereinafter referred to as an “experimental example”) and a case where an insulator is formed on a dielectric layer made of polymer resin and a conductive substance in accordance with the conventional technology (hereinafter referred to as a “comparative example”). These examples are compared with a single layered dielectric in terms of the reduction ratio of capacitance, dielectric constant and dielectric loss.

TABLE 1

| | Capacitance | Dielectric constant | Dielectric loss |
|---|---|---|---|
| Experimental | 30% decreased | 15% decreased | 35% decreased |
| example | | | |
| Comparative | 50% decreased | 50% decreased | 15% decreased |
| example | | | |

In the case of the present experimental example, the dielectric substance 120 is implemented in a multi-layered structure by forming BiZnNb oxides, for example, Bi5Zn1Nb3/2O7, on the first dielectric layer 122 made of polymer resin and a conductive substance. Accordingly, as shown in Table 1, the capacitance is decreased by 30%, the dielectric constant by 15% and the dielectric loss by 35%, in comparison with the single layered dielectric made of the first dielectric layer 122.

By contrast, in the case of the comparative example, a multi-layered dielectric substance is implemented by forming an insulation thin film on a dielectric layer made of polymer resin and a conductive substance. Accordingly, as shown in Table 1, the capacitance and the dielectric constant are decreased by 50%, and the dielectric loss is decreased by 15%, in comparison with the single layered dielectric made of the first dielectric layer 122.

That is, in the case of the present experimental example, the dielectric loss is decreased by 35% compared with the single layered dielectric made of the first dielectric 122, and it is even significantly higher than 15%, which is the reduction ratio of dielectric loss of the comparative example. Likewise, the reduction ratios of the capacitance and dielectric constant are 30% and 15%, respectively, for the experimental example, and it is also significantly lower than 50%, which is the reduction ratio of the capacitance and dielectric constant of the comparative example.

In other words, as described above, since dielectric constant tends to decrease as its dielectric loss is lowered, the comparative example according to the conventional technology shows that, while the dielectric loss is decreased by 15%, the dielectric constant and the capacitance of the capacitor are significantly decreased by at least 50%.

By contrast, in the case of the present experimental example, although the dielectric loss is decreased by 35%, the dielectric constant and the capacitance of the capacitor are only decreased by 15% and 30%, respectively, by forming the multi-layered dielectric substance 120, which is implemented by forming the thin-film second dielectric layer 124, which has less dielectric loss than the first dielectric layer 122 and, more specifically, is made of BiZnNb oxides having a dielectric constant of greater than 4 and less than the dielectric constant of the first dielectric layer 122, on the first dielectric layer 122 made of polymer resin and a conductive substance. Accordingly, as shown in Table 1, the reduction of the capacitance and the dielectric constant can be minimized, and at the same time the dielectric loss can be reduced.

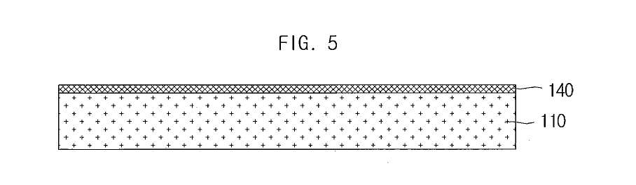

Next, a method of manufacturing the capacitor 100 in accordance with an embodiment of the present invention will be described with reference to FIGS. 5 to 10.

FIGS. 5 to 10 are cross-sectional views illustrating each process of manufacturing the capacitor 100 in accordance with an embodiment of the present invention.

Firstly, as illustrated in FIG. 5, the magnetic layer 140 is formed on one surface of the first electrode 110 made of copper (Cu) or gold (Au). The present process is performed by, for example, depositing cobalt (Co), iron (Fe) or nickel (Ni) by way of sputtering, and the magnetic layer 140 can be formed with a thickness of, for example, 1 micrometer or less.

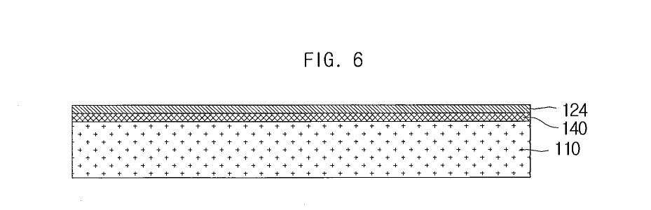

Secondly, as illustrated in FIG. 6, a portion of the second dielectric layer 124 is formed on one surface of the magnetic layer 140. The second dielectric layer 124 can be formed by way of, for example, sputtering, and the second dielectric layer 124 can be formed with a thickness of, for example, 1 micrometer or less.

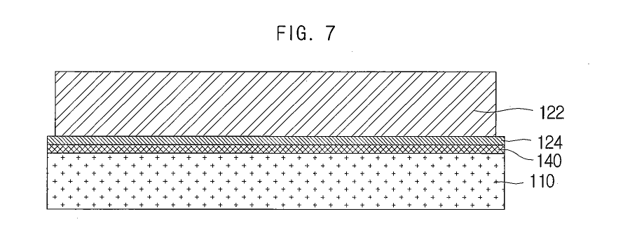

Thirdly, as illustrated in FIG. 7, the first dielectric layer 122 is formed on the second dielectric layer 124. The first dielectric layer 122 can be formed by printing, for example, dielectric paste, and the first dielectric layer 122 can be formed with a greater thickness than the second dielectric layer 124.

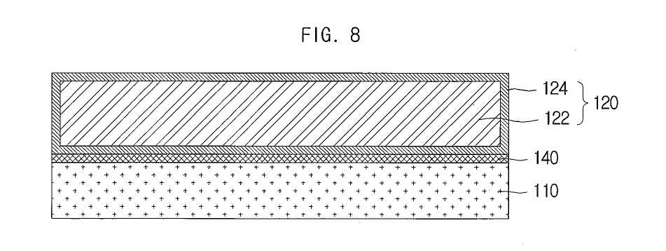

After these processes, as illustrated in FIG. 8, the remaining portion of the second dielectric layer 124 is formed on the first dielectric layer 122. Like the process of forming the portion of the second dielectric layer 124, the remaining portion of the second dielectric layer 124 can be formed with a thickness of 1 micrometer or less by way of sputtering. In this case, the remaining portion of the second dielectric layer 124 can be formed such that the remaining portion of the second dielectric layer 124 can surround the first dielectric layer 122.

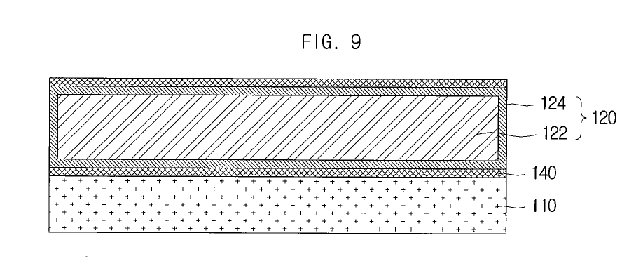

Next, as illustrated in FIG. 9, another magnetic layer 140 is formed on the remaining portion of the second dielectric layer 124. The present process is also performed by, for example, depositing cobalt (Co), iron (Fe) or nickel (Ni) by way of sputtering, and the present magnetic layer 140 can be formed with a thickness of, for example, 1 micrometer or less.

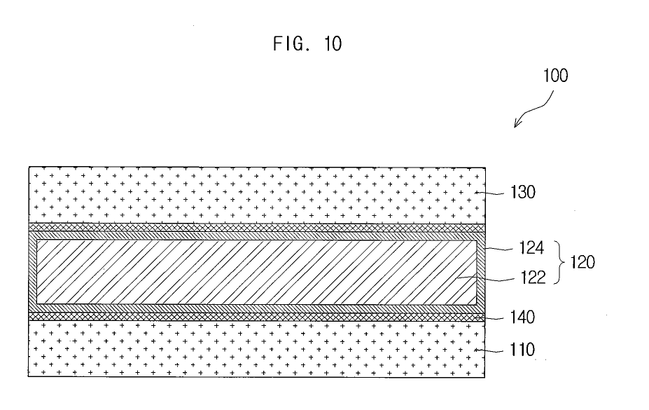

Then, as illustrated in FIG. 10, the second electrode 130 is formed on the magnetic layer 140. The second electrode 130 can be made of copper (Cu) or gold (Au) and formed, for example, by way of sputtering or through the evaporation.

While the spirit of the invention has been described in detail with reference to a particular embodiment, the embodiment is for illustrative purposes only and shall not limit the invention. It is to be appreciated that those skilled in the art can change or modify the embodiment without departing from the scope and spirit of the invention. As such, many embodiments other than that set forth above can be found in the appended claims.

What is claimed is:

1. A capacitor comprising:
a first electrode;
a dielectric substance formed on the first electrode;
a second electrode formed on the dielectric substance; and
a magnetic layer interposed between the dielectric substance and at least one of the first electrode and the second electrode.

2. The capacitor of claim 1, wherein the magnetic layer is made of a material comprising at least one selected from a group consisting of cobalt (Co), iron (Fe) and nickel (Ni).

3. The capacitor of claim 1, wherein the magnetic layer is interposed both between the first electrode and the dielectric substance and between the second electrode and the dielectric substance.

4. The capacitor of claim 1, wherein the dielectric substance comprises:
a first dielectric layer; and
a second dielectric layer formed on the first dielectric layer and having less dielectric loss than the first dielectric layer.

5. The capacitor of claim 4, wherein a dielectric constant of the second dielectric layer is greater than 4 and smaller than a dielectric constant of the first dielectric layer.

6. The capacitor of claim 4, wherein the second dielectric layer is made of a material comprising metal oxide.

7. The capacitor of claim 6, wherein the metal oxide is an amorphous substance.

8. The capacitor of claim 7, wherein the metal oxide is made of a material comprising at least one selected from a group consisting of BiZnNb oxides, BiTi oxides, BiNb oxides, BiCuNb oxides and BiMgNb oxides.

9. The capacitor of claim 4, wherein the first dielectric layer is made of a material comprising polymer resin and a conductive substance.

10. The capacitor of claim 9, wherein the conductive substance is made of a material comprising at least one selected from a group consisting of carbon black, carbon nanotube, carbon nanowire, carbon fiber, metal, metal oxide and graphite.

11. The capacitor of claim 4, wherein the second dielectric layer is formed on one surface and the other surface of the first dielectric layer.

12. The capacitor of claim 11, wherein the second dielectric layer is formed to surround the first dielectric layer.
